(19) United States
(12) Patent Application Publication
(10) Pub. No.: US 2005/0171794 A1
(43) Pub. Date: Aug. 4, 2005

(54) Method and system for reaching conflict resolution

(75) Inventor: Daniel Lubetzky, New York, NY (US)

Correspondence Address: MORRISON & FOERSTER LLP, 755 PAGE MILL RD, PALO ALTO, CA, 94304-1018, US

(73) Assignee: PeaceWorks Foundation

(21) Appl. No.: 10/769,639

(22) Filed: Jan. 30, 2004

(51) Int. Cl. G06F 17/60

(52) U.S. Cl. 705/1; 705/80

(57) ABSTRACT

A method for weighted voting is disclosed which includes receiving a plurality of votes on a corresponding plurality of predefined propositions from a voter. If the voter casts positive votes on one or more propositions, count the positive votes as absolute support of the one or more propositions. If the voter casts negative votes on one or more propositions, prompt the voter to allocate a number of negative points for each negative vote. Record the votes and the negative points allocated to each negative vote to create a voting report. A method for multi-tier voting includes receiving a plurality of votes on a corresponding plurality of predefined propositions from a voter, optionally prompting the voter to select an alternative proposition for each corresponding vote from a set of predefined alternative propositions, furnishing each proposition in a particular tier with an optional set of alternative propositions in a lower tier, and recording the votes and the alternative proposition selected.

### FIELD OF THE INVENTION

The present invention relates to the field of business methods. In particular, the present invention relates to a method and system for reaching conflict resolution.

### BACKGROUND OF THE INVENTION

With all the newspaper headlines and TV images of the violent extremism and enmity between Israelis and Palestinians, it is not surprising that the prevailing perception is that neither side desires a peaceful resolution to the age-old conflict. The media rarely focuses its attention on the fact that the vast majority of the population actually holds moderate views, and would prefer prosperity and coexistence to prolonged bloodshed.

According to a joint survey of Israeli and Palestinian public opinion conducted by Konrad Adenauer Foundation, a majority from both sides agreed with mutual recognition of Palestine as the State of the Palestinian people and Israel as the State of the Jewish people, but the public from either side misperceives the position of the other. The majority of people from both sides also support the Roadmap for Peace. Once a peace agreement is reached and a Palestinian state established a full 80% of Israelis and 71% of Palestinians support reconciliation between the two peoples.

Violent extremists represent only a small minority of the Israeli and Palestinian population, yet they hold a disproportionate amount of power by fomenting fear in the minds of the public. In addition, they receive an unfair share of free publicity on their campaign of terror. This disproportionate media attention on the radical, absolutist minority in turn encourages misunderstanding, fear and mistrust among the silent majority of peaceful Palestinians and Israelis, resulting in apathy towards civic engagement. Each time efforts to reach a diplomatic resolution are resumed, violent extremists derail the peace process through an endless cycle of dehumanizing terror.

Although other civil programs put out commendable efforts towards resolving conflicts in the Middle East, such efforts do not directly involve the majority of Israeli and Palestinian people in the negotiation process. Instead, these groups prepared documents that favor their own agendas and a small group of representatives are involved in the negotiation. Often, the agendas being advanced are originated from certain political parties or individuals, and they are not uniformly endorsed by Israeli, Palestinian, Arab, European and American civic and government leaders. In addition, the current programs and efforts do not employ the state-of-the-art technologies to reach out to all citizens concerned. And such efforts have been focusing on the end result and ignoring the value of the process that can bring awareness to the obstacles that prevent peaceful resolution as well as the nonviolent steps that can be taken towards conflict resolution. Therefore, there is a need for a method and system that address the above problems and complement the existing efforts in resolving conflicts in the Middle East.

### SUMMARY

The disclosed method is an undertaking to reassert the will of the people at the grassroots level through a constructive and educative approach engineered to yield concrete results. It is built upon a neutral forum that has been endorsed by many experts with years of wisdom in working towards peace in the Middle East. The disclosed method gives a forceful voice to the overwhelming majority of people in the region that would stand to condemn violence and endorse coexistence, but whose voices have been drowned out by extremists. Individuals will craft an agenda through a broad-based interactive process, rooted on the premise that an agreement is not intractable, and that respected experts confirm the answers have been laid out in prior negotiations and, based on polls, would meet the support of the people, particularly as leaders they respect start shattering myths and abstract fears and endorsing realistic compromises.

The disclosed method is not merely a forum for discussion. It is designed to iteratively extract ten propositions for conflict resolution with broad-based support. These propositions constitute a formal grassroots roadmap, also known as the mandate of the people, which can impel the leadership to listen and act on behalf of the people. It is an important grassroots complementary effort to the essential work that diplomats have done through the diplomatic Roadmap.

A method for reaching conflict resolution between Israelis and Palestinians includes creating a proclamation of principles of reconciliation that represents the will of the majority Israeli and Palestinian people, making support for the proclamation of principles of reconciliation as a condition to register to participate in a subsequent negotiation process, creating an iterative democratic negotiation process to achieve consensus on a predetermined number of propositions for conflict resolution, and creating a mandate of the people in accordance with consensus achieved by the iterative democratic negotiation process.

A system for maximizing the reach of all participants includes means for supporting communications with participants via the Internet, means for supporting communications with participants via a voice activated phone system, and means for supporting communications with participants via a traditional physical medium.

A method for weighted voting includes receiving a plurality of votes on a corresponding plurality of predefined propositions from a voter. If the voter casts positive votes on one or more propositions, count the positive votes as absolute support of the one or more propositions. If the voter casts negative votes on one or more propositions, prompt the voter to allocate a number of negative points for each negative vote. And record the votes and the negative points allocated to each negative vote to create a voting report.

A method for multi-tier voting includes receiving a plurality of votes on a corresponding plurality of predefined propositions from a voter, optionally prompting the voter to select an alternative proposition for each corresponding vote from a set of predefined alternative propositions, furnishing each proposition in a particular tier with an optional set of alternative propositions in a lower tier, and recording the votes and the alternative proposition selected.

### BRIEF DESCRIPTION OF THE DRAWINGS

The aforementioned features and advantages of the invention as well as additional features and advantages thereof will be more clearly understood hereinafter as a result of a detailed description of embodiments of the invention when taken in conjunction with the following drawings.

FIG. 1 illustrates a method for reaching conflict resolution in accordance with an embodiment of the present invention.

FIG. 2 illustrates the procedures of the democratic negotiation process 112 of FIG. 1.

FIGS. 3A and 3B illustrate two examples of the weighted voting method for assisting voters to prioritize issues they care most about in accordance with an embodiment of the present invention.

FIG. 4A illustrates a method of multi-tier voting for bridging differences between conflicting parties in accordance with an embodiment of the present invention.

FIG. 4B illustrates a method of multi-tier voting for identifying potential compromises between conflicting parties in accordance with an embodiment of the present invention.

FIG. 5 illustrates a voting system in accordance with an embodiment of the present invention.

### DESCRIPTION OF EMBODIMENTS

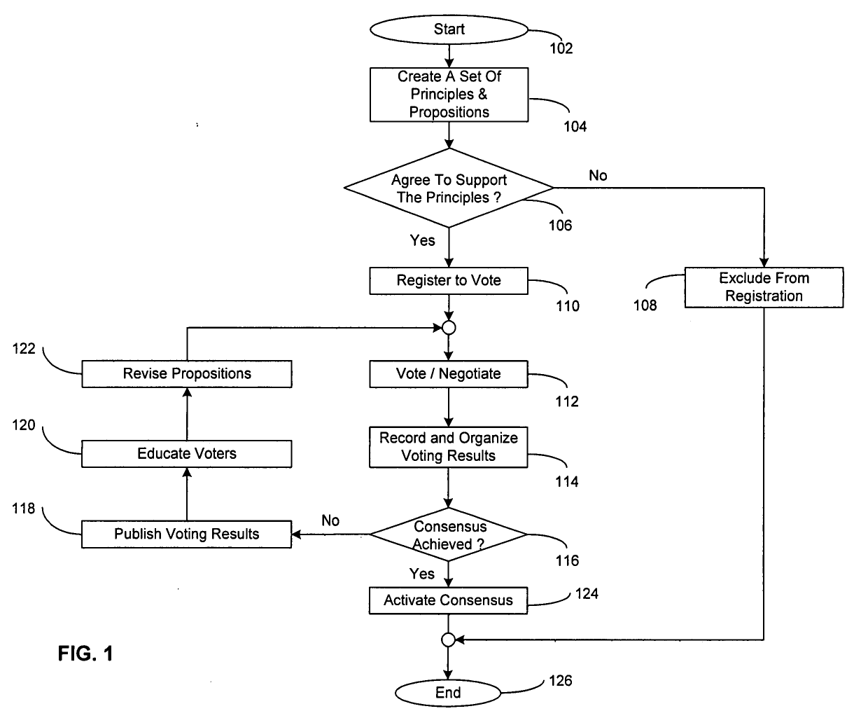

FIG. 1 illustrates a method for reaching conflict resolution in accordance with an embodiment of the present invention. The method includes three stages for assisting the majority of Israelis and Palestinians to participate in a democratic process to achieve a peaceful conflict resolution. The method starts in step 102 and thereafter moves to step 104 where the method formulates a set of principles. The set of principles is also known as the proclamation of principles of reconciliation or proclamation of principles for participation, that both sides can use as commonly accepted values, such as the right of both peoples to live with freedom, security, dignity, and independence. The set of principles outline the basic commitments that each side must make in order to move towards a peaceful resolution of the conflict. Most people from both sides already support diplomatic efforts to end the conflict through a two-state solution. And most people already agree that there needs to be an end to the occupation and to the killing of innocent civilians by terrorists. However, they don't realize that the other side also accepts these basic principles because of the false polarization created by the media. These principles act to re-ignite hope and build trust between the two communities. The principles also act as a filter to exclude extremists from participating in the conflict resolution process because they would not support the principles. In addition, an expert panel from both sides can distill and synthesize a set of key propositions for resolving the Israeli-Palestinian conflict based on prior and existing official, civic and/or academic agreements and proposals.

In step 106, the method reaches out to as many individuals as possible, presenting them with the set of principles, and trying to register voters to participate in a democratic negotiation process. Dignitaries and celebrities are recruited to endorse the principles and encourage their communities to adopt the principles and register to vote. The comprehensive outreach method includes using the Internet, newspapers, telephone, civil society organizations, and a door-to-door signature drive to achieve a critical mass of supporters. Also in step 106, a first inquiry is made to a potential voter whether s/he agrees to support the set of principles. If the potential voter does not agree to support the set of principles (106_No), the potential voter is excluded from registration to vote in step 108. In the alternative (106_Yes), if the potential voter agrees to support the set of principles, s/he is permitted to register to vote in step 110. This participation filter is designed to ensure that only moderates who disavow absolute rejection participate in the conflict resolution negotiations. The system is designed to amplify voices of the majority and help them reach consensus; it is not a platform for poll-taking, but for conflict resolution. For example, extremists trying to undermine the system would face a quandary because in order to vote, they would have to affirm the principles, which would increase the number of participants supporting the principles of reconciliation, sending a signal of moderation that undermines the extremists' objectives. If the extremists support the principles dishonestly, they still cannot undermine the system because not only do they increase the number of supporters of the principles of reconciliation, but they also cannot absolutely reject the propositions, as will be seen below.

In steps 112 to 122, the method engages the registered voters in an iterative democratic negotiation process to achieve broad-based consensus on the set of key propositions for resolving the conflict. In step 112, by using various means of communications, such as the Internet, voice activated phone systems, and traditional post office mails, registered voters can affirm (by casting a positive vote) or reject (by casting a negative vote) each proposition. In step 114, the voting results are recorded and organized. In step 116, a second inquiry is made as to whether consensus of the majority is achieved, if consensus is not achieved (116_No), the method moves to step 118.

In step 118, the voting results are published. Through the published voting results, views of the majority can be established and areas of conflict can be identified. People can learn about the current status of the conflicts and their implications for the future of the region. In step 120, the method educates the voters about the voting results. The education campaign involves goodwill tours, town hall meetings, interviews, satellite media tours and other informational events. Through the educational programs, voters can learn the art of negotiation and the importance of making compromises, while shattering myths, taboos and fears, and building understanding and a respect for non-violent civic and democratic means for conflict resolution. In step 122, the method reformulates creative propositions and alternatives and explores solutions to any intractable issues that may arise. In this step, the propositions may be revised for the next round of voting. Through this iterative process, participants can receive feedback after each round of voting until consensus is reached.

In the alternative (116_Yes), consensus is achieved on the set of key propositions, the method continues in step 124. Once consensus is achieved, broad numbers of participating voters will have a stake in the process because they have helped to shape the mandate of the people. The method activates the newly established mandate of the people to advocate for a peaceful resolution to the Arab-Israeli conflict by creating accountability of the leaders to follow the will of the people. The mandate of the people can provide political cover and propel leaders to implement the vision of the people in their diplomatic efforts, or face replacement by other leaders who implement the will of the people. The method ends in step 126.

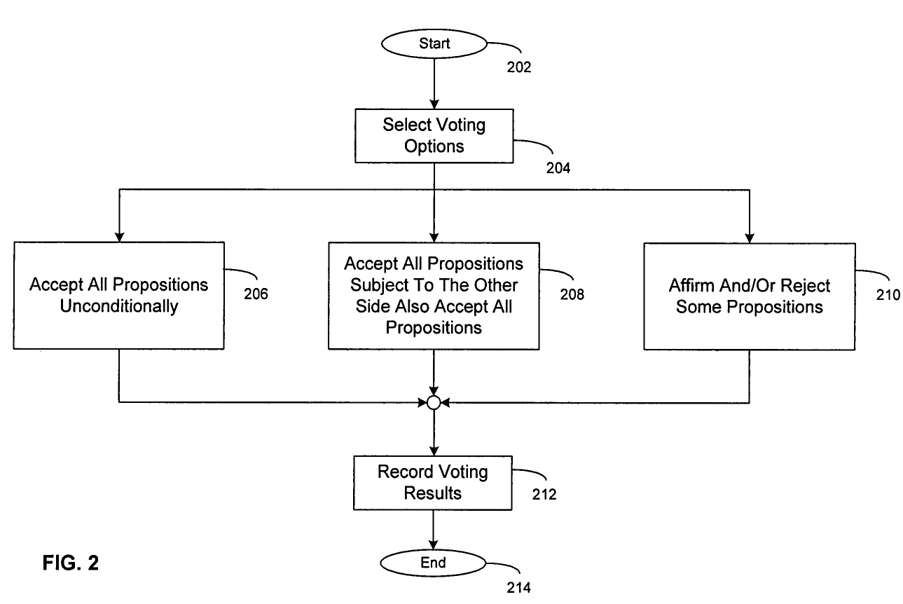

FIG. 2 illustrates the procedures of the democratic negotiation process 112 of FIG. 1. The method starts in step 202 and thereafter moves to step 204 where a voter selects one of the three voting options. In the first alternative that the voter chooses to accept all propositions unconditionally, the method moves to step 206, and the voter's acceptance is considered as an absolute acceptance of the outstanding propositions.

In the second alternative that the voter chooses to accept all propositions subject to the condition that the other side also accepts all proposals, the method moves to step 208, and the voter's acceptance is considered as a conditional acceptance of the outstanding propositions. The reason behind this contingent uniform approval mechanism is that although some Israelis and Palestinians may want a peaceful resolution of the conflicts, they may be suspicious of the process and are not ready to make a commitment unless the other side also makes a commitment to the peaceful resolution of the age-long conflict between the two peoples. By providing a choice to show people's willingness to compromise, the method teaches people that there is more moderation on the other side, and it advances the peaceful conflict resolution process with a significant forward step. This process overcomes a persistent problem in conflict resolution—the scenario of who goes first with each side wanting the other to take the first step. This process allows both sides to take a step forward in unison and make their commitment contingent upon the other side also making the same commitment.

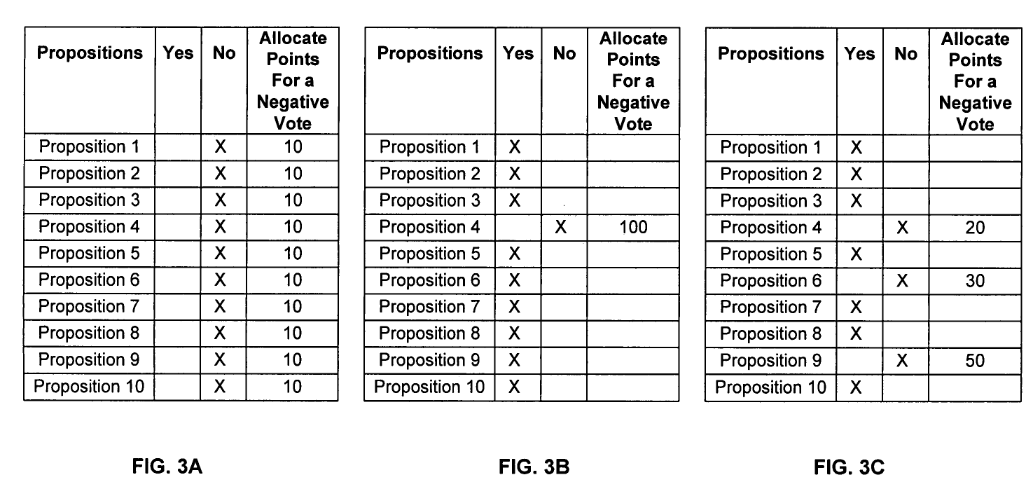

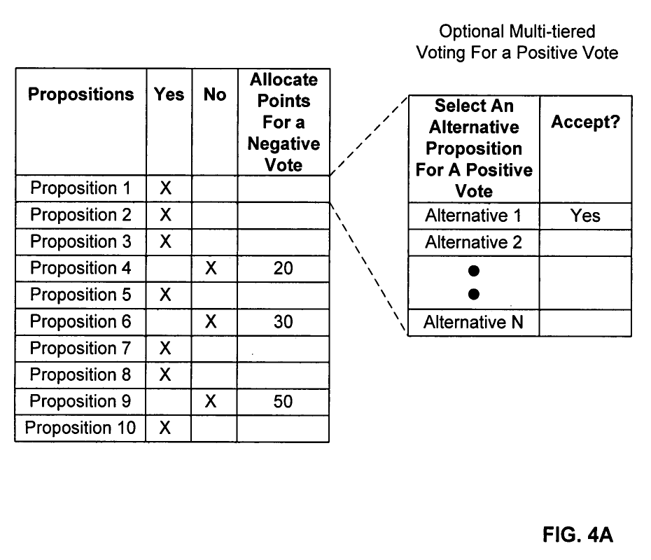

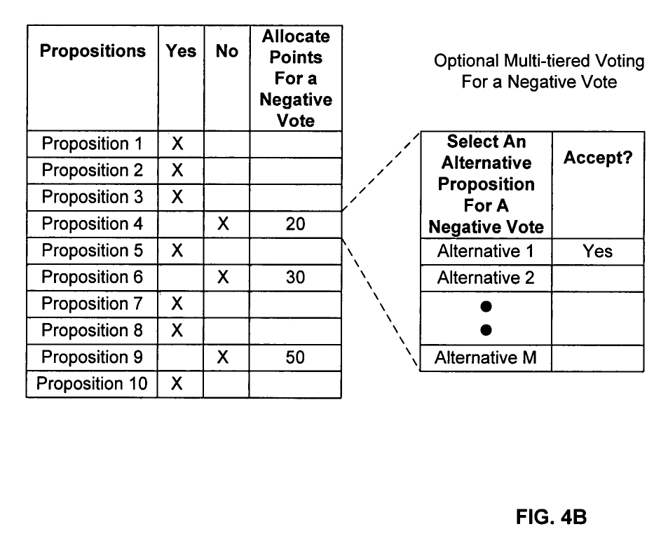

In the third alternative that the voter chooses to affirm and/or reject some propositions, the method moves to step 210. By choosing the third alternative, the voter can vote on each proposition individually and prioritize the issues based on one's own preferences. A weighted voting mechanism is employed to assist voters to emphasize the issues they care most about and educate them about the art of making compromises. The weighted voting mechanism is described in detail below in association with the description of FIGS. 3A, 3B and 3C. In addition, a multi-tier voting mechanism is employed to assist voters to identify potential compromises between the conflicting parties on a controversial proposition. The multi-tier voting mechanism is described in detail below in association with the description of FIGS. 4A and 4B. In step 212, the voting results are recorded and the method ends in step 214.

FIGS. 3A, 3B and 3C illustrate three examples of the weighted voting method for assisting voters to prioritize issues they care most about in accordance with an embodiment of the present invention. FIG. 3A shows a table that describes a scenario when a voter or participant chooses to reject all the propositions. The first column describes a predetermined number of propositions the voter is to vote on. The predetermined number of propositions can be arbitrary, and for simplicity, 10 propositions are used in this example. The second column allows voters to cast “Yes” votes to the corresponding propositions, and the third column allows voters to cast “No” votes to the corresponding propositions. In one embodiment, the voter enters negative votes to all 10 propositions. In the fourth column, the voter allocates a number of negative points to each negative vote. As part of the voting rules, each voter receives a predetermined number of negative points to allocate amongst its negative votes. For simplicity, 100 points are used in this example. The voter can not use more than its pre-allocated negative points. In one embodiment, the voter chooses to use the negative points evenly among all 10 propositions, resulting in 10 negative points allocated to each proposition, thus diluting the weight of each negative vote. This method educates people to prioritize the issues they care most about; it discourages people from blindly rejecting all propositions because doing so dilutes the weight of each individual rejection. In fact, the optimal way to highlight their heartfelt protest is not through total rejection but through making compromises. Through the process of prioritizing and evaluating the propositions, voters become more involved in the democratic negotiation process, and they are consciously making compromises in their selection of issues that they may reject.

FIG. 3B shows a table that describes another scenario when a voter chooses to reject only one proposition. In another embodiment, the voter casts a “No” vote only proposition 4 and “Yes” votes to the rest of the nine propositions. In this case, the voter may allocate all the negative points, i.e. 100 points, to proposition 4 and therefore magnifying the issue the voter cares most about. FIG. 3C shows a table that describes yet another scenario when a voter rejects a few propositions. In yet another embodiment, the voter casts a “No” vote to propositions 4, 6 and 9, and casts a “Yes” votes to the rest of the propositions. In this example, the voter may allocate 20, 30, and 50 negative points to propositions 4, 6, and 9 respectively. Again, as illustrated in FIGS. 3B and 3C, the weighted voting method teaches voters the need to prioritize their issues; the method prevents absolute rejection without costs. The method also provides experts a deliberative and clear result highlighting challenges that need additional attention.

FIG. 4A illustrates a method of multi-tier voting for bridging differences between conflicting parties in accordance with an embodiment of the present invention. For each proposition, an optional tier of alternatives are presented to the participants. This method applies to situations when a particular proposition is extremely hard to reach consensus at the outset, in other words, the conflicting parties may be too far apart at the beginning to agree on one proposition that may satisfy both sides. So rather than forming a proposition which both sides or one side will reject, the method aims to narrow the area of disagreement and discussion, by providing two or more alternatives for resolving a particularly thorny issue.

For example, if proposition 1 is particularly hard for both sides to reach consensus, then a set of alternative propositions are created in an optional tier, and the original proposition 1 may be simplified to state whether the voter agrees with any of the alternative propositions 1 to N. These alternatives may overlap or may represent completely different paths, but they are aimed at making compromises that move the parties from total rejection to acceptance of compromising positions. If a voter casts a “Yes” vote to proposition 1, then s/he is prompted to select an alternative proposition from the subsequent tier of alternatives 1 to N. In this example, the voter chooses alternative 2. Note that the above technique is not limited to one optional tier, but it may be applied to include multiple tiers of alternatives. In other words, a set of new alternatives may be formed to further fine tune each of the alternatives in the previous tier. Through analyzing participants' selection results and educating the participants about the benefits of making compromises, the subsequent iterations of the democratic voting process can then focus the parties on propositions formulated in accordance with the previous selection results from the alternatives that most participants may accept, thus moving the parties towards consensus through an iterative process.

FIG. 4B illustrates a method of multi-tier voting for identifying potential compromises between conflicting parties in accordance with an embodiment of the present invention. In addition to allocating a number of negative points to each rejection vote, the voter may also choose from an optional tier of alternative propositions that may be used to replace the current proposition. For example, when the voter casts a negative vote to proposition 4, s/he is presented with a predetermined number of alternative propositions that are used to identify potential compromises. In this multi-tier voting scheme, the voter is prompted to choose an alternative proposition from a set of predefined alternative propositions 1 to M. If the voter does not make a selection, a default proposition is considered to be selected. Similarly, the above technique is not limited to one optional tier, but it may be applied to include multiple tiers of alternatives. In other words, a new set of alternatives may be formed to further fine tune each of the alternatives in the previous tier. This multi-tier voting scheme further assists voters to consider alternatives that may lead to a compromise. This method also provides valuable information to the experts for revising the propositions for subsequent rounds of voting.

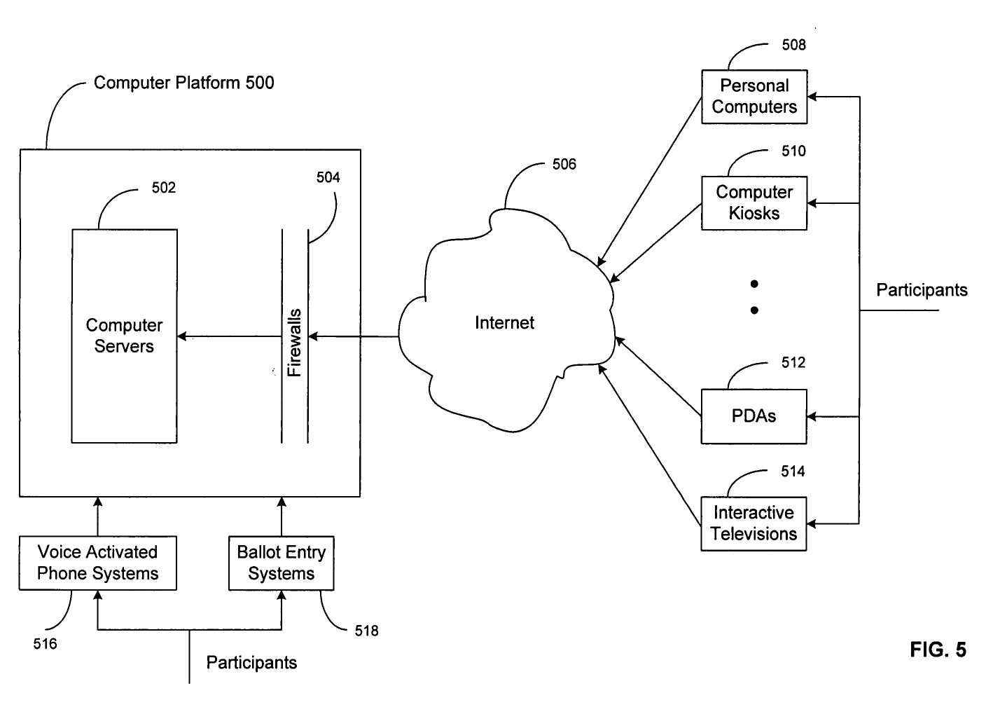

FIG. 5 illustrates a voting system in accordance with an embodiment of the present invention. The voting system includes a computer platform 500 which comprises computer servers 502 and firewalls 504. The computer platform 500 interfaces with personal computers 508, computer kiosks 510, personal digital assistances (PDAs) 512 and interactive televisions 514 via the Internet 506. It also operates multiple websites on the Internet, broadcasting the message of conflict resolution in different languages such as Arabic, English and Hebrew. The computer platform 500 also supports voice-activated phone systems 516 that allow voters to cast their votes through telephones and cellular phones as well as supports ballot entry systems 518 that allow voters to cast their votes through traditional paper mediums. The computer platform further maintains a database for handling registration of voters and verifying registration. Through the computer platform, Israelis and Palestinians can learn about the conflict resolution process, sign the proclamation of principles of reconciliation, vote on the propositions for conflict resolution, participate in interactive discussions, and show their support of their political leaders with specific actions.

Computer kiosks 510 are installed throughout the Palestinian territories and Israel. Given that Internet penetration in Israel is about 70%, compared to only about 20% within Palestinian society, a majority of the computer kiosks are installed at host non-government organization sites on the Palestinian side. The computer kiosks within Israel are located in low-income neighborhoods with high concentrations of Ethiopian, Sephardic, Russian, Bedouin, Druze and Israeli Arab residents to ensure equitable access to the on-line computer platform. The participating nonprofit organizations can encourage their members to sign the proclamation, vote on issues, and join the conflict resolution process.

Unlike the digital divide that characterizes Internet access in the region, over 80% of Palestinians and 90% of Israelis have either a cellular and/or a home phone. Voice-activated phone systems 516 are used to enable callers to vote on issues and register their support for the conflict resolution process by calling a confidential toll-free number. Voices of celebrities are recorded as phone prompts and instructions on how to use the voice-activated phone systems 516.

To complement the reach of the innovative computer platform, traditional media strategies include placing full-page advertisements in national, regional, and community newspapers throughout Israel and the Palestinian territories. The advertisements can broadcast the conflict resolution message and enable readers to participate by faxing and mailing their ballots printed in newspapers. Similarly, billboard and street-sign advertisements are posted around the region. These advertisements can reach majority of Israelis and Palestinians and influence them to participate in the conflict resolution process. Signature drives are organized to connect with residents of Palestinian villages and refugee camps. This face-to-face method is effective at spreading the message of nonviolence, trust and cooperation. Furthermore, public service announcements are created to counter the unfair share of media coverage given to extremists when they commit an atrocity. The public service announcements are aired on radio stations throughout the region.

Other forms of communications of the conflict resolution process are designed to block violent extremists from derailing conflict resolution efforts and to create broad-based reach to the general public. A series of satellite media tours, goodwill tours, town hall meetings, and the Palestinian-Israelis business council are organized with the participation of diplomats, celebrities, religious authorities, business leaders and scholars. In particular, satellite media tours are produced with three to five minute videos of the conflict resolution message, which can be broadcasted via satellite throughout Israel, Palestine, and the Arab world.

Goodwill tours are arranged to Israel and Palestine featuring celebrities, religious figures, dignitaries, scholars, and business leaders to convey the conflict resolution message that relates to their field. For the movie stars, the message is: “True Heroes Fight for Peace;” for the spiritual leaders, it is: “Let no one hijack our religions with messages of hatred;” for the business sector: “Terror and violence hurt our economy; peace brings prosperity;” for experts and scholars: “Answers are out there. Let us break myths, overcome entrenched symbols, and discuss concrete possible solutions;” and for dignitaries: “Diplomatic efforts and non-violence are the only effective means of resolving this conflict and bringing peace to the region. Violent extremism works against the people, so the people must stand up against it.” Media coverage of the goodwill tours, such as newspaper articles, TV and radio interviews, are leveraged to maximize the awareness created by the tours.

Town hall meetings are organized to amplify the voice of people and strengthen civic discourse as nonviolent means for conflict resolution. The Town Hall meetings may feature a conversation between the Palestinian prime minister and civil society leaders. Audience has opportunity to discuss their concerns, apprehensions, and desires, and to hear the prime minister's vision for success. The Palestinian community can ask the prime minister questions in person, over the phone or via the Internet. Hundreds of thousands of people can view the town hall meeting on TV, hear it on the radio, or read about it in the press. The similar event may be held in Israel, follow by a meeting between Palestinians and an Israeli leader, another event where Israelis will talk with the Palestinian Prime Minister, and finally, a town hall meeting of leaders and citizens from both sides.

A Palestinian and Israeli business council are formed to identify obstacles to prosperity, discuss ways to improve the business climate, and develop action-oriented strategies for joint economic development. Participants can explore the possibility of creating a venture capital fund for Israeli-Palestinian projects, as well as forming an expert advice network to provide technical assistance to Palestinian entrepreneurs and expand exports.

The disclosed method for reaching conflict resolution offers at least a number of improvements over the existing efforts. First, the disclosed method enables negotiation by the people. Rather than having two small groups of representatives negotiate their own agendas, the disclosed method gathers experts to draft conflict resolution propositions and allows ordinary Palestinians and Israelis to affirm or reject these propositions until a mandate for conflict resolution is shaped by a broad base of citizens. The process engages individuals and gives them a sense of ownership and responsibility, investing them with the recognition that they need to stand up against violent extremism and participate in the process to isolate forces of terror if they are to help support their political leaders on their drive to resolve the conflict.

Second, the disclosed method not only has the end results in sight, it also focuses on the process people can take to achieve the end results. It provides a democratic negotiation process to enable people to be accountable in the conflict resolution process and facilitate them to reach consensus through their participation; the agendas are not tied to any particular interest groups or individuals, but to the will of the people. By enabling regular citizens to prioritize their protests and preventing absolute rejectionism through the weighted-voting mechanism, the process helps educate people about the need for negotiation and the reality that peace requires compromises and cannot be expected without a level of flexibility from both sides.

Third, the disclosed method is uniformly endorsed by Israeli, Palestinian, Arab, European and American civic and government leaders. It is not associated with any particular political parties or individuals as the organization includes dignitaries from all major parties and constituencies. Because the process involves the majority of Israelis and Palestinians, it is difficult for anyone to seek to de-legitimize this process that embodies participatory democracy at its best.

Fourth, the disclosed system is uniquely built on cutting-edge technology platforms to allow participants to use the Internet, voice-activated phone systems as well as traditional paper mediums to have their voices heard. The communications are designed to enable all citizens to participate.

One skilled in the relevant art will recognize that there are many possible modifications of the disclosed embodiments that could be used, while still employing the some basic underlying mechanisms and methodologies. For example, other means of communications via the Internet can be utilized, and other forms of physical media can be used to enable individuals to participate in the conflict resolution process.

The foregoing description, for purpose of explanation, has been described with references to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A method for reaching conflict resolution between Israelis and Palestinians, comprising:
creating a proclamation of principles of reconciliation that represents the will of the majority Israeli and Palestinian people;
making support for the proclamation of principles of reconciliation as a condition to register to participate in a subsequent negotiation process;
creating an iterative democratic negotiation process to achieve consensus on a predetermined number of propositions for conflict resolution; and
creating a mandate of the people in accordance with consensus achieved by the iterative democratic negotiation process.

2. The method of claim 1, wherein creating the proclamation of principles of reconciliation comprises outlining the basic commitments that Israeli and Palestinian people must make in order to move towards a peaceful conflict resolution.

3. The method of claim 1, wherein the step of making support comprises:
if a participant supports the proclamation of principles of reconciliation, registering the participant in the subsequent negotiation process; and
if the participant does not support the proclamation of principles of reconciliation, excluding the participant from the subsequent negotiation process.

4. The method of claim 1, wherein the step of creating an iterative democratic negotiation process comprises:
recording votes from participants on a predetermined number of conflict resolution propositions;
organizing votes from all participants to create a voting report;
if consensus between the Israelis and Palestinians is not achieved, repeating the iterative democratic negotiation process; and
if consensus between the Israelis and Palestinians is achieved, exiting the iterative negotiation process.

5. The method of claim 4, further comprising:
publishing the voting report; and
educating participants about implications of the voting report.

6. The method of claim 4, further comprising:
revising the conflict resolution propositions in response to the voting report for the subsequent negotiation process.

7. The method of claim 1, further comprising:
activating the mandate of the people to propel political leaders to implement the will of the people.

8. A system for maximizing the reach of all participants, comprising:
means for supporting communications with participants via the Internet;
means for supporting communications with participants via a voice activated phone system; and
means for supporting communications with participants via a traditional physical medium.

9. The system of claim 8, wherein the means for supporting communications with participants via the Internet comprises:
one or more computer servers for interfacing with devices on the Internet; and
one or more firewalls for providing security protection to the one or more computer servers.

10. The system of claim 8, further comprising:
means for registering a participant; and
means for verifying registration of the participant.

11. The system of claim 8, further comprising:
means for supporting voting by participants via the Internet;
means for supporting voting by participants via the voice activated phone system; and
means for supporting voting by participants via the traditional physical medium.

12. A method for weighted voting, comprising:
receiving a plurality of votes on a corresponding plurality of predefined propositions from a voter;
if the voter casts positive votes on one or more propositions, counting the positive votes as absolute support of the one or more propositions;
if the voter casts negative votes on one or more propositions, prompting the voter to allocate a number of negative points for each negative vote; and
recording the votes and the negative points allocated to each negative vote to create a voting report.

13. The method of claim 12, wherein the voter allocates a number of negative points to each negative vote.

14. The method of claim 12, wherein each voter receives a predetermined total number of negative points for use on negative votes, and wherein the sum of all negative points allocated to all negative votes equal to the predetermined total number of negative points.

15. The method of claim 12 further comprising:
if the voter casts conditional positive votes on all propositions subject to the other side also casts conditional positive votes to all propositions, counting the conditional positive votes as conditional support of all propositions; and
recording the conditional positive votes.

16. A method for multi-tier voting, comprising:
receiving a plurality of votes on a corresponding plurality of predefined propositions from a voter;
optionally prompting the voter to select an alternative proposition for each corresponding vote from a set of predefined alternative propositions; and
recording the votes and the alternative propositions selected.

17. The method of claim 16, further comprising:
if the voter does not make a selection from the set of predefined alternative propositions, making a default proposition as the selected alternative proposition.

18. The method of claim 16, further comprising:
furnishing each proposition in a particular tier with an optional set of alternative propositions in a lower tier.
